(19) United States
(12) Patent Application Publication
(10) Pub. No.: US 2022/0374918 A1
(43) Pub. Date: Nov. 24, 2022

(54) DATA-DRIVEN INDEX FOR IDENTIFICATION AND RANKING OF COMPANIES FOR A SELECTED TECHNOLOGY

(71) Applicant: EMC IP Holding Company LLC, Hopkinton, MA (US)

(72) Inventors: Yaseen Tamer Refaie Moussa, Cairo (EG); Mohamed Ahmed Amr Abouzeid, Cairo (EG); Abdulrahman Mohamed Diaa Eldin, Cairo (EG); Osama Taha Mohamed Abdelbaky, Cairo (EG)

(21) Appl. No.: 17/314,315

(22) Filed: May 7, 2021

(51) Int. Cl. G06Q 30/02; G06Q 50/18; G06F 16/22

(52) U.S. Cl. CPC G06Q 30/0201; G06Q 50/184; G06F 16/2228

(57) ABSTRACT

One example method includes identifying companies involved in development and/or use of a technology, and identifying the companies includes identifying datasets from which features are to be extracted, wherein each feature comprises an aspect of one of the companies that relates to the technology, and extracting the features from the datasets. Next, the method includes selecting a subset of the identified companies, for each feature assigned to a company in the subset, normalizing a value of the feature relative to respective values of all other features assigned to that company, assigning a weight to each of the features whose value has been normalized, calculating, for each company in the subset, an index value based on the features assigned to that company and the weights assigned to those features, and generating an index that ranks the companies in the subset by their respective index values.

### FIELD OF THE INVENTION

Embodiments of the present invention generally relate to data analysis. More particularly, at least some embodiments of the invention relate to systems, hardware, software, computer-readable media, and methods for selection and analysis of datasets to provide insights regarding companies and their technologies.

### BACKGROUND

Companies, such as multinational technology companies for example, spend millions of dollars annually to be able to identify the top companies in each related technology. Particularly, such companies usually try to identify their top customers, competitors and partners. These companies extract such insights by hiring market and technology experts who make predictions as to who the top customers are, and who actual and potential competitors and partners are. Typically however, such predictions will include errors and biases that have not been identified, or accounted for.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 is a graphical depiction illustrating weights used for each dataset and each feature used in an example Who Index.

FIG. 2 is a graphical depiction illustrating a handful of a group of companies, as listed in an example Who index.

FIG. 3 is a detail view of a portion of the graphical depiction of FIG. 2.

FIG. 4 discloses an example method according to one or more embodiments of the invention.

FIG. 5 discloses aspects of a computing entity operable to perform any of the disclosed methods and processes.

### DETAILED DESCRIPTION OF SOME EXAMPLE EMBODIMENTS

Embodiments of the present invention generally relate to data analysis. More particularly, at least some embodiments of the invention relate to systems, hardware, software, computer-readable media, and methods for selection and analysis of datasets to provide insights regarding companies and their technologies.

Information technology companies usually spend a significant amount of time and money to identify who are their current and future partners, customers and competitors. These companies try to gain insights by hiring experts to perform analyses and make predictions about, for example, the future of the market. However, these experts may err in predicting who the stakeholders of the company will be in the future, and the experts may introduce bias and other problems into their analyses and predictions. Thus, some example embodiments of the invention may be directed to various approaches to obtain insights using a data driven approach that may reduce, or avoid, problems such as those noted above.

For example, some embodiments embrace a method to identify and rank the top companies for a given technology, using an automated data-driven method to combine several datasets through an automated approach. To this end, embodiments may provide for creation and employment of a weighted average index. This index may include, for example, statistical features from various data sources, examples of which include, but are not limited to, Google Trends, job listings from Indeed.com, an indicator if a company was mentioned as a sample vendor by Gartner, DBpedia labeled News articles extracted from FactForge, and patent and patent application data from Google Patents.

The index may be fully customized for any market context of the selected technology by allocating and selecting weights for each data source to reflect a particular market context that may be of interest. The quality of the index may be dependent on the quality of the datasets employed in creation of the index. Therefore, the reliability of an index may be directly correlated with the data injected. The quality of the data may be subject to biases for certain companies, labeling and being up to date.

Thus, one example output of a method according to one or more embodiments may be a weighted average index that may be specific to a particular technology, such as 5G for example. The index may be generated based on (i) identified features for each of a plurality of companies, (ii) respective computed weights for each of a plurality of companies, and (iii) various optimization constraints. An example index may include a list of companies ranked according to their respective ‘Who Index’ norm in which, for example, a company ‘A’ with a Who Index norm of 100 would be ranked first, and another company ‘B’ with a Who Index norm of 12 would be ranked below the company with the Who Index norm of 100.

In general, the Who Index norms and rankings may correlate with the relative status and/or state of development of one or more technologies. Thus, in some instances, a Who index may include norms and rankings that have been determined and assigned to a particular company which may correspond, for example, to a relative extent to which that company is a leader in technology research, development, and implementation, in a particular technological field. With reference to the preceding example, company ‘A’ may thus be identified as a leader in a technological field, while company ‘B’ may be a relatively minor participant in that field. This index information may be used, for example, by company ‘A’ looking to acquire smaller entities such as company ‘B’ who may be developing possibly specialized technologies. As another example, the index information may be used by a business entity such as company ‘B’ that may be interested in a partnership or other arrangement with a leading entity such as company ‘A.’

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that such embodiments may be able to accurately identify the state of a particular technology or field of technology, notwithstanding errors in a dataset, and/or biases in a dataset toward, or against, a particular company involved in some way with that technology. An embodiment of the invention may determine a relative extent to which a company is involved in research and development of a particular technology.

It is noted that embodiments of the invention, whether claimed or not, cannot be performed, practically or otherwise, in the mind of a human. As indicated by the illustrative examples disclosed herein, embodiments of the invention are applicable to, and find practical usage in, highly dynamic environments which include large, and constantly changing, datasets that may be analyzed on an ongoing basis, using multiple different variables and queries, to identify, for example, a state of development of a technology, and/or of a technology field. Such large datasets and complex analyses are well suited to the practical generation of useful results, but such analyses, performed with respect to those datasets, are simply beyond the mental capabilities of any human to perform practically, or otherwise. Thus, where one or more simplistic examples may be disclosed herein, those are only for the purpose of illustration and to simplify the discussion. Nothing herein should be construed as teaching or suggesting that any aspect of any embodiment of the invention could or would be performed, practically or otherwise, in the mind of a human.

A. Overview

In the rapidly changing world of technology and innovation, there is a persistent need to prepare for the circumstances of the future. Example embodiments may achieve this, following the scientific and mathematical discourse, by creating and using models that attempt to explain the current system, and then extrapolate, based on that model, predictions about the future of the system.

This process may be rigorous, and in example embodiments may start with defining the scope. For example, embodiments may be directed to attempting to model the top companies that are working on each technology in the future, by creating an index which may sort the top companies within each technology. Such indexes, which may additional or alternatively, indicate the state of development a particular technology and/or technological field, produced by example embodiments of the invention may be referred to as a “Who index.”

In some example embodiments, the Who index may be generated based on a variety of different datasets from different respective paradigms. For example, some embodiments may take into consideration different datasets related to industry, academics, job opportunities, and news. Such embodiments may combine the insights obtained from these datasets to identify, such as through statistical modelling for example, the top companies in each technology. What constitutes a ‘top’ company, or leading technology/technological field, may vary from one embodiment to another and may, for example, be flexibly defined according to various specified criteria and features.

Example embodiments may embrace, among other things, forecasting techniques for complex systems, with a view towards being able to predict how the system of variables and factors may behave, and what that system may look like at one or more points in the future. Many conventional techniques may depend on statistical analysis or learning models created to explain the behavior of a selected group of data features over time. However, it is challenging to make such predictions and forecasts using a data-driven approach such as that employed by example embodiments of the invention, because the size of the needed data grows exponentially with the increase in the complexity of the system.

To use a data-driven approach to determine the status of technologies, embodiments of the invention may determine what data would be useful and appropriate for the task. Thus example embodiments may employ a collection of data features selected or computed from a group of open-source datasets. These features may serve as primary variables for the study of an ecosystem of technologies. Embodiments of the invention may involve running several tests on the data of the features to identify the features most effective at describing the system. The resulting collection of features may then be pre-processed to reach an acceptable form before being inserted into a model. Analyses performed by some embodiments may use, for example, bibliometric features from patents datasets, insights from the market using a job opportunities and news datasets, and a relative popularity feature from search trends data. Following is a discussion of some challenges that were presented, and overcome, in the development and use of some example embodiments of the invention.

As noted earlier, conventional approaches used by some experts in the field may generate predictions about technology development, and top technology companies, that are based on, and/or include, erroneous data and information. Thus, some example embodiments may embrace a statistical model which may inform a prediction process using a data-driven approach which may help to minimize their errors and biases. In general, embodiments of the invention may employ a set of data features/parameters from any data source, whether open-source data or internal to a company for example, to rank the top companies for different areas of technology, and/or for other considerations such as technology development, and technology markets, for example.

Another challenged addressed in development of some example embodiments concerns the sorting of top companies in each technology. Particularly, there was a need to choose the best algorithm and statistical analysis to sort the companies in each technology.

Yet another challenge that was addressed in development of some example embodiments was the need to identify relevant datasets and features. Particularly, in order to produce a relevant and informative index, high quality datasets may be chose, as the reliability of an index may be directly correlated with the data used. Datasets are subject to biases and relevance problems, and the challenge is to effectively find and select datasets that contain appropriate features.

A final example of a challenge that was addressed in development of some example embodiments was the need to find the best weights for each dataset to create the Who index. In particular, to be able to sort the members of the index in an effective and efficient way, there was a need to find the best set of weights for each feature in the datasets. These weights would then enable creation and use of a weighted average index, as implemented by one or more example embodiments. For each company and each technology, every dataset may have to have its own respective weight to alter the final score based on the relative importance of the dataset in a particular technology area. Thus, identification and selection of the right set of weights was a significant challenge to be overcome in development of embodiments of the invention.

### B. Aspects of Some Example Embodiments

Example embodiments of the invention may be directed to, among other things, an approach for identifying and ranking companies investing in a certain technology, using an automated and data-driven method. Some example embodiments may employ a three step automated process that may be used to address, for example, the following challenges: company identification; features engineering, using processes such as identification, extraction, and normalization; and weights estimation. After this three step process has been performed, example embodiments may apply a weighted average to the set of features, and the outputs normalized to generate an index, such as a Who index for example. In some of the illustrative examples disclosed herein, the data may be extracted from sources such as, but not limited to, Indeed.com, Google Trends, Gartner, FactForge, and Google patents. Additional, or alternative, data sources may be employed in other embodiments.

B.1 Company Identification

Initially, some example embodiments may identify, in an unsupervised way, the companies that are related to a selected technology. This unsupervised approach may eliminate the introduction of any human biases in the company selection process. Some embodiments may employ one or more datasets in the company identification process.

In one example embodiment, a jobs dataset may be extracted from Indeed.com and the sample vendors mentioned by Gartner. Jobs that are related to the selected technology, such as 5G, cloud computing, or chip technology, for example, may be extracted, and then this job data aggregated by company and ranked from the most job offerings to the least, per company. The job data may further be processed, for example, to eliminate job offerings not directly pertaining to the technology, such as jobs in the accounting department, and/or to segregate the job data by role, or technology type for example.

From the list of companies ordered by job offerings, a given number of companies, such as the top 10 percent for example, may be selected from the top to be nominated for further analysis and ranking. This list of selected companies may then be compared and joined with one or more other lists compiled based on different respective datasets, which in the aforementioned illustrative example may be the Gartner sample vendors (see, e.g., https://www.gartner.com/en).

The compiled list of companies may be automatically corrected as needed, such as for divisions within a company, so that, for example, the mention of Dell and Dell Technologies as two different companies would be limited to one company name by selecting the shorter name, which is simply ‘Dell’ in this example. Embodiments of the invention may also employ a named-entity-recognition model to be able to extract the company names from different datasets. A named-entity-recognition model may operate to unify the company names across different datasets, such as in the ‘Dell’ example above, by using a pretrained model that may detect the company names in text, which may utilize predefined company lists, such as the one offered by DBpedia (https://www.dbpedia.org/) for example.

B.2 Feature Engineering

After identifying and compiling a list of companies that are related in one or more ways to the selected technology, a set of features may be identified, extracted and normalized for every company in the list. Example embodiments may employ features for an index, such as the example features set forth in Table 1 below. In our experiment, we identified several features to be used in our index. As indicated below, Table 1 lists these features, their data source, their market context, and a short description.

Thus, for example, the feature name ‘patent_granted_20XX’ refers to the number of patents granted to a particular company during a particular timeframe. As shown, this information concerning granted patents may be obtained, for example, from the Google patents website. Further, patents may relate or be relevant to a ‘technical innovation’ dimension or aspect of a market or company. The specific number of patents granted to a company may serve as an indicator as to, for example, the relative scope, and pace, of technology development in a particular company.

TABLE 1
Identified Features

| | | Market | |
|---|---|---|---|
| Feature Name | Data Source | Context | Description |
| jobs_count | Indeed.com | Human | Count of jobs offered by this |
| | | Resources | company in this technology |
| | | Investment | |
| gartner_flg | Gartner | Analyst | Binary flag if the company |
| | | Opinion | was listed as a sample |
| | | | vendor by Gartner for a |
| | | | selected technology |
| 20XX_mean − std | Google Trends | General Public | Mean Google Trend index |
| | | Relations | for this company with a |
| | | | selected technology − |
| | | | standard deviation in 20XX |
| 20XX_mean + std | | | Mean Google Trend index |
| | | | for this company with a |
| | | | selected technology + |
| | | | standard deviation in 20XX |
| (20XX, ‘max’) | | | Max Google Trend index in |
| | | | 20XX |
| (20XX, ‘min’) | | | Min Google Trend index in |
| | | | 20XX |
| news_20XX | FactForge | Market | Count of news articles that |
| | | Sentiment | mention this company and |
| | | | the selected technology in |
| | | | 20XX |
| patent_granted_20XX | Google Patents | Technical | Count of patents granted by |
| | | Innovation | this company in this |
| | | | technology in 20XX |
| patent_filed_20XX | | | Count of patents filed by |
| | | | this company in this |
| | | | technology in 20XX |

Following the identification of one or more features of interest, the process of extraction may begin. The extraction process may be different for every dataset, but may begin with obtaining the raw dataset(s) from which the features will be extracted. The raw data may be processed independently for each dataset to extract the selected features, such as one or more of the examples identified in Table 1, for every company that was shortlisted in the company identification process, and for the selected technology. The selected features may then be scaled with respect to all the other companies for every given feature. This scaling may be performed, for example, by using min-max normalization. Normalization may be required since the range of values of a dataset may vary widely and, thus, a feature may have a relatively higher weight in the index simply because that feature contains larger values than the other features, which would introduce unnecessary, and misleading, biases into the index.

To briefly illustrate, if a jobs count is 100, but the number of patents granted is 5000, an erroneous conclusion may be drawn that the number of patents granted is somehow more significant or carries greater weight than the jobs count, even though that may not necessarily be the case. Thus, the normalization process may result in identification of a common reference, or baseline, that can be used as a basis to compare values of different features.

B.3 Weights Estimation

After extraction of the features needed for the index, a respective weight may be estimated or selected for each of the features. Embodiments of the invention may employ various methods and processes for weight estimations, one of which may be based on a manual approach, and based on solving an optimization problem.

In the relatively simpler manual approach for weights estimation would be the manual approach, the expected user of the index may identify the market context the user is interested in and then the weights for each feature of the index may be manually selected with respect to this selection. The selection may be performed by allocating relatively higher weights for the identified market context, for example. However, this relatively naïve approach may introduce biases, as a result of the manual weight selection, and could cause the index to be mainly or unduly estimated based on a limited set of features.

Other embodiments may employ an automated approach to weights estimation. This automated approach may be better understood and appreciated with reference to the example process of portfolio diversification in finance. In general, diversification refers to the process of allocating capital in a way that reduces the exposure to any one particular asset or risk. A common path towards diversification is to reduce risk or volatility by investing in a variety of assets. In this context, the selected features may be treated as assets in order to diversify the index with as many data sources as possible, while also minimizing the volatility of the index.

For an example automated approach, an optimization problem may be identified as the need to minimize the variance of a portfolio, or index, of features with respect to the weights. A portfolio (index) variance σₚ may be defined as:

σₚ=Σᵢ₌₁ⁿΣⱼ₌₁ⁿwᵢwⱼCov(fᵢ, fⱼ), where ‘n’ refers to the number of features selected, wₓ refers to the weight allocated for feature ‘x’ and Cov(fₓ, f_{y}) refers to the covariance of features ‘x’ and ‘y’ in the index.

For this example optimization problem, a goal may be to minimize the value of the variance σₚ in the aforementioned equation by changing the weights allocated for each feature while setting two main constraints, namely, (1) for the sum of the weights to be equal to 100% and (2) for the weights to have strictly positive values. Other sets of constraints may be defined as well, such as a maximum and minimum weight per feature, and a maximum and minimum weight per dataset. Solving this optimization problem with the mentioned set of constraints may produce the allocated weights that minimize the volatility of the index, and also diversify the data sources.

In one alternative approach, instead of minimizing the variance of the index, the inverse of the coefficient of variation of the index may be maximized. The coefficient of variation is calculated as the standard deviation of the portfolio divided by the mean of the portfolio. The mean of the portfolio may be defined as:

μₚ=Σᵢ₌₁ⁿwᵢE[fᵢ], where ‘n’ refers to the number of features selected, wₓ=MEV refers to the weight allocated for feature x and E[fₓ] refers to the mean of feature ‘x’ in the index. The inverse of the coefficient of variation may be defined as

$$C {V}^{- 1} = \frac{{μ}_{p}}{{σ}_{p}} .$$

As such, maximizing this equation may result in minimizing the variance of the index, while also maximizing the mean of the index. This approach may be similar to the diversification approach, in finance, of maximizing the Sharpe ratio, where the same equation is maximized, but the mean is adjusted for the risk-free rate by subtraction. This approach may utilize the same constraints and potentially yield relatively better weights, as maximizing the mean of the index.

B.4 Index Computation

The final step in some example embodiments is to calculate the index value for every identified company, using the selected features and computed weights. For the raw index values, a weighted average may be applied to the set of features using the estimated weights. The raw index values may be computed as: I_{raw}(x)=Σᵢ₌₁ⁿwᵢ*f_{x,i} for every company ‘x,’ where ‘n’ refers to the number of features selected, wₓ refers to the weight allocated, and f_{x,i} refers to the value of feature i for company ‘x.’ Finally, the results may be scaled using min-max normalization and then ranked in a descending order.

The final output after the index values have been calculated, and then weighted, is the normalized ranked index for which companies or other entities are involved in the selected technology, scaled between 100 and 0. This output may then be used for various applications, such as determining how a certain company ranks relative to its peers, and identifying key competitors in a given technology, for example.

C. Example Cases and Considerations

C.1 5G Technology

In one illustrative example, 5G technology was used as the basis for the application of an embodiment of the invention. In general, this involved identification of companies, identification of features, and a weights estimation process that comprised maximizing the inverse of the coefficient of variance to estimate the feature weights.

Solving the optimization problem for this 5G example resulted in the weights shown in Table 2 below.

TABLE 2
Computed Weights

| Feature Name | Weight |
|---|---|
| jobs_count | 25.0% |
| gartner_flg | 4.0% |
| 2016 mean − std | 1.6% |
| 2016 mean + std | 1.3% |
| (2016, ‘max’) | 1.5% |
| (2016, ‘min’) | 1.0% |
| 2017 mean − std | 1.2% |
| 2017 mean + std | 1.3% |
| (2017, ‘max’) | 1.4% |
| (2017, ‘min’) | 1.0% |
| 2018 mean − std | 1.6% |
| 2018 mean + std | 1.2% |
| (2018, ‘max’) | 1.3% |
| (2018, ‘min’) | 1.1% |
| 2019 mean − std | 1.1% |
| 2019 mean + std | 1.1% |
| (2019, ‘max’) | 1.1% |
| (2019, ‘min’) | 1.0% |
| 2020 mean − std | 1.1% |
| 2020 mean + std | 1.0% |
| (2020, ‘max’) | 1.0% |
| (2020, ‘min’) | 1.0% |
| news_2017 | 9.7% |
| news_2018 | 9.6% |
| news_2019 | 9.5% |
| patent_granted_2020 | 9.1% |
| patent_filed_2020 | 9.2% |
| SUM | 100% |

As shown in the example of Table 2, a constraint was introduced in the 5G example for the Gartner feature for that feature to be less than or equal to only 4%, as Gartner was taken, in this example, to be a biased source. By limiting the feature value to 4% or less, the effect of the Gartner feature on the overall index was accordingly limited. The constraints can be seen in Table 3, below.

TABLE 3
Optimization Constraints
Constraints

| | |
|---|---|
| Sum of Weights | 100% |
| Max Weight per Feature | 25% |
| Min Weight per Feature | 1% |
| Max Weight per Data | 40% |
| Max Gartner_flg Weight | 4% |

Finally, the index was generated using the selected features and the generated weights from Table 2 and Table 3Table, respectively. Table 4, below, shows a sample of the top 25 companies in the index. These results were reviewed by parties knowledgeable concerning 5G technology, and it was confirmed by these parties that this index, in Table 4, does represent the top players in 5G and accurately ranks them with respect to each other.

It is noted that many Chinese firms, such as Huawei for example, are missing from Table 4, due to limitations in the Jobs dataset, where the companies used were extracted from the Indeed US website. This circumstance is due to dataset limitation and could be resolved by simply retrieving data from the Indeed Chinese website.

TABLE 4
Who Index for 5G Example

| Rank | Company | Who Index Norm |
|---|---|---|
| 1 | Samsung | 100.0 |
| 2 | Verizon | 80.8 |
| 3 | Nokia | 61.1 |
| 4 | Qualcomm | 53.9 |
| 5 | AT&T | 45.7 |
| 6 | Ericsson | 44.9 |
| 7 | Intel | 43.5 |
| 8 | Apple | 37.0 |
| 9 | T-Mobile | 24.1 |
| 10 | Cisco | 12.0 |
| 11 | Mavenir | 12.0 |
| 12 | Micron | 10.4 |
| 13 | DISH | 8.4 |
| 14 | Synopsys | 5.4 |
| 15 | Lenovo | 5.4 |
| 16 | LCC | 4.4 |
| 17 | BTI | 4.1 |
| 18 | CommScope | 3.3 |
| 19 | ION | 3.3 |
| 20 | National Instruments | 3.3 |
| 21 | Spirent | 3.2 |
| 22 | Connectivity | 3.1 |
| 23 | MN | 1.9 |
| 24 | Dell | 1.6 |
| 25 | Global Technology Associates | 1.3 |

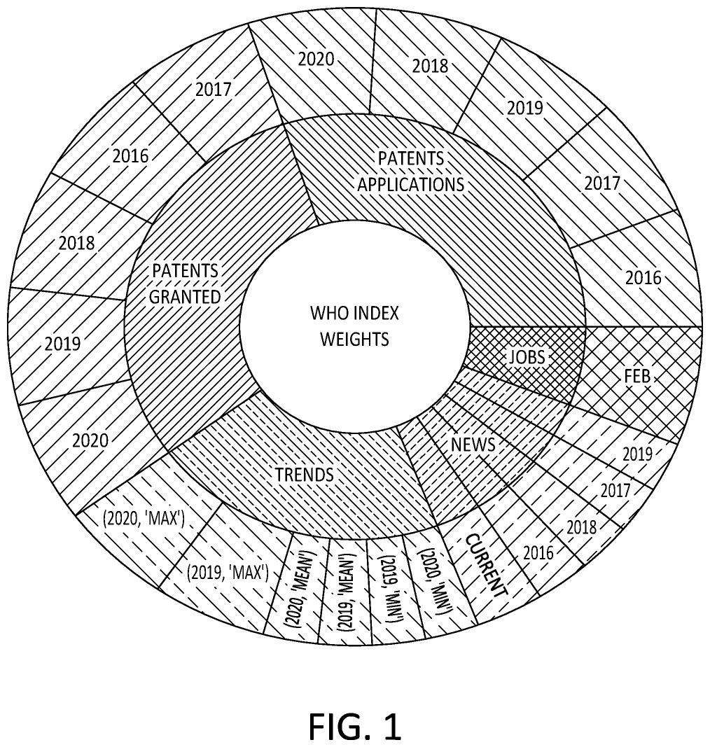

With reference next to FIG. 1 (Who index with weights for cloud computing technology), the graphic indicated there shows the weights used for each dataset and each feature used in an example Who Index. These weights reflect the relative importance of each data source to the Who Index values. As These weights were produced from solving the optimization problem explained in the disclosure. This plot is a graphic visualization for a “computed weights table,” one example of which is Table 2.

As shown in the illustrative example of FIG. 1, the respective weights of ‘Patents Granted’ and ‘Patent Applications’ is approximately the same, and together total approximately ⅔ of the total weight in the index. The remaining ⅓ of the weight in the index is provided by ‘Trends,’ News,′ and ‘Jobs,’ with the ‘Trends’ having the greatest weight of these three.

The example graphic of FIG. 1 also indicates the time periods for which data was gathered for each of the features. For example, the ‘Patents Granted’ data was collected for the years 2016-2020. While the graphic of FIG. 1 indicates, for example, that the number of patents granted each year was approximately the same, it should be appreciated that the number of patents granted may vary, sometimes significantly, from one year to another. These same considerations apply as well to the other features indicated in FIG. 1.

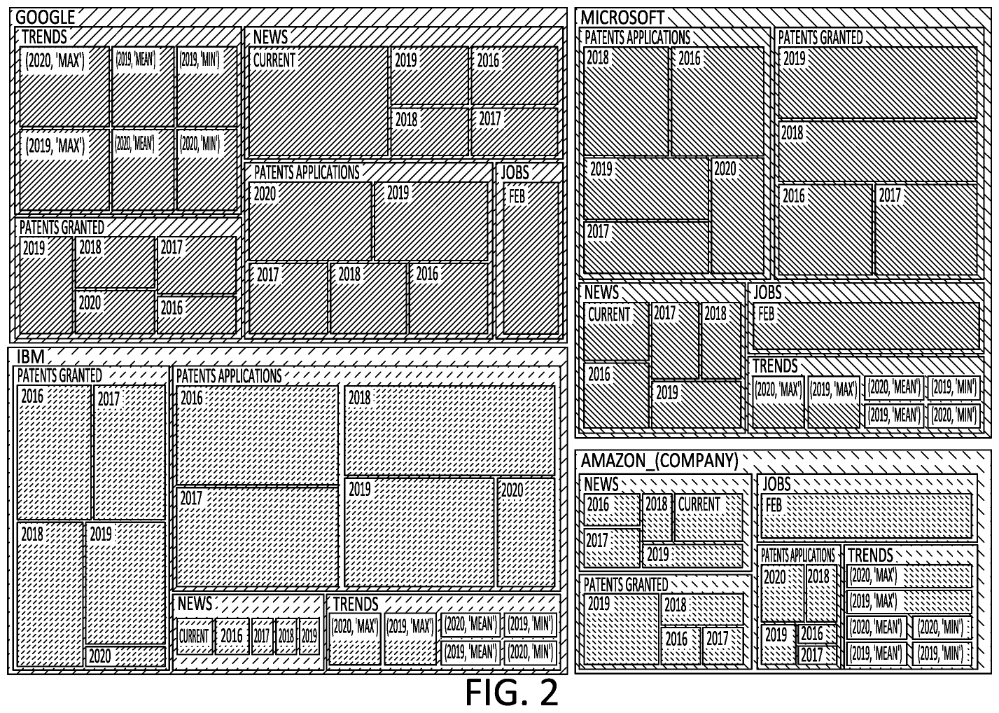

With reference next to FIG. 2 (top 25 companies Who index for cloud computing technology), a graphic is disclosed that shows a handful of the top 25 companies, as listed in an example Who index. In this example, the companies are Google, Microsoft, IBM, and Amazon. Each of these companies is represented by a respective box whose size corresponds to the relative rank of that company in a Who index for a particular technology. Thus, in the example of FIG. 2, the indicated companies may be ranked, from highest to lowest, Google, IBM, Microsoft, and Amazon. The plot also shows the contribution of each feature and data source to the Who Index for a given technology where, again, the size of each box corresponds to the company proportion of the given feature or data source in the Who Index.

Thus, for example, it can be seen that the ranking of IBM is due largely to the ‘Patents Granted,’ and ‘Patent Applications’ filed, for that company. On the other hand, ‘Trends’ and ‘News’ play a relatively larger role in the ranking of Google than they do in the ranking of IBM.

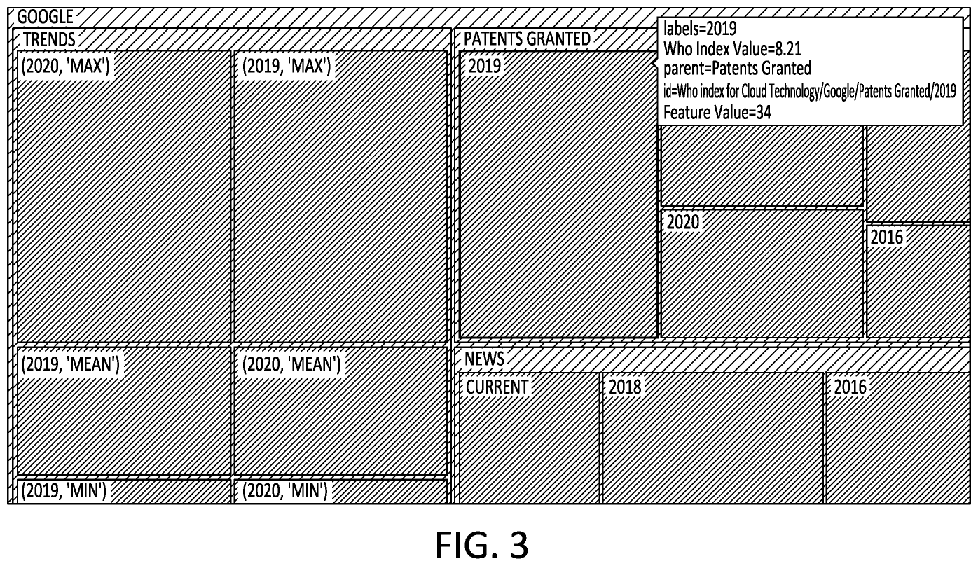

With attention now to FIG. 3, a graphic may be configured to display further detail when a user hovers over, or otherwise selects, one of the indicated boxes. In the example of FIG. 3, a zoomed in example is shown for the number of 2019 patents granted that are related to Cloud for Google.

C.2 Cloud Technology

In another example, cloud technology was used as the basis for the application of an embodiment of the invention. That is, ‘cloud’ was used as the technology term. In general, this involved identification of companies, identification of features, and a weights estimation process that comprised maximizing the inverse of the coefficient of variance to estimate the feature weights.

For the cloud example, the data was retrieved using the datasets and the process outlined disclosed elsewhere herein. However, the cloud example also added an entity recognition model that utilizes DBpedia data to unify the datasets in a more refined way. For this example, the inverse of the coefficient of variance was maximized to estimate the feature weights.

Solving the optimization problem, the weights shown in Table 5, below, were obtained.

TABLE 5
Computed Weights

| Feature Name | Weight |
|---|---|
| jobs_feb | 6.00% |
| trends_2019_mean | 2.50% |
| trends_2020_mean | 2.50% |
| trends_2019_min | 2.50% |
| trends_2020_min | 2.50% |
| trends_2019_max | 5.37% |
| trends_2020_max | 5.42% |
| news_2016 | 2.50% |
| news_2017 | 2.50% |
| news_2018 | 2.50% |
| news_2019 | 2.50% |
| news_current | 3.21% |
| patent_granted_2016 | 6.00% |
| patent_granted_2017 | 6.00% |
| patent_granted_2018 | 6.00% |
| patent_granted_2019 | 6.00% |
| patent_granted_2020 | 6.00% |
| patent_filed_2016 | 6.00% |
| patent_filed_2017 | 6.00% |
| patent_filed_2018 | 6.00% |
| patent_filed_2019 | 6.00% |
| patent_filed_2020 | 6.00% |
| SUM | 100% |

For computing the weights, a set of constraints were used to obtain the results, as explained in elsewhere herein. The constraints are set forth below in Table 6.

TABLE 6
Optimization Constraints
Constraints

| | |
|---|---|
| Sum of Weights | 100% |
| Max Weight per Feature | 6% |
| Min Weight per Feature | 2.5% |

Finally, the index was generated using the selected features and the generated weights from Table 4 and Table 6, respectively. Table 7, below, shows a sample of the top 25 companies in the index.

TABLE 3
Who Index for Cloud

| Rank | Company | Who Index |
|---|---|---|
| 1 | Google | |
| 2 | IBM | 89.6 |
| 3 | Microsoft | 81.7 |
| 4 | Amazon_(company) | 44.9 |
| 5 | Samsung | 42.3 |
| 6 | Oracle_Corporation | 40.0 |
| 7 | Commvault | 24.8 |
| 8 | Adobe | 21.5 |
| 9 | Intel | 21.5 |
| 10 | AT&T | 20.2 |
| 11 | Apple_Inc. | 18.0 |
| 12 | Sonos | 17.0 |
| 13 | Sony | 14.9 |
| 14 | Cisco_Systems | 14.4 |
| 15 | Facebook | 14.2 |
| 16 | VMware | 13.5 |
| 17 | Salesforce.com | 12.9 |
| 18 | OneTrust, LLC | 10.9 |
| 19 | Magic_Leap | 10.2 |
| 20 | Huawei | 7.5 |
| 21 | Splunk | 6.3 |
| 22 | Ethicon_Inc. | 6.1 |
| 23 | Citrix_Systems | 5.8 |
| 24 | Dell | 4.7 |
| 25 | General_Electric | 4.3 |

### D. Example Methods

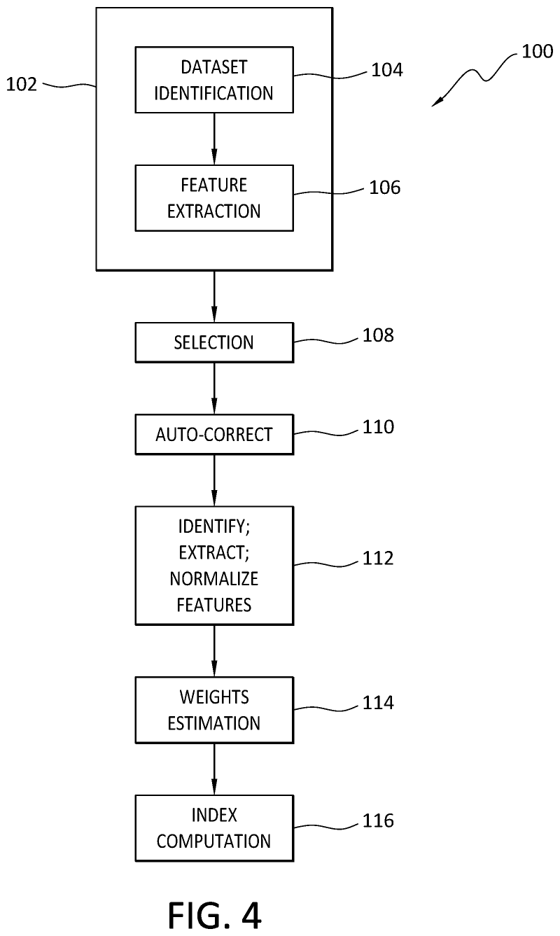

It is noted with respect to the example method of FIG. 4 that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Directing attention now to FIG. 4, an example method 100 is disclosed for generating an index that identifies and ranks entities, such as companies for example, according to their respective involvement in a particular technological field. The rankings and index weights may also indicate a relative state of development of a technology and/or technological field.

The example method 100 may begin by identification 102 of one or more companies involved in some way with a particular technology. The identification 102 may be made in an unsupervised way, without human involvement. Such identification 102 may thus involve identification 104 of one or more datasets, and extraction 106 of data from the datasets.

Next, one or more companies may be selected 108 from the list of companies identified at 102. The selection 108 may be according to a criterion, such as the top 10 percent of companies for example, or the top 20 companies. At 110, an auto-correction process may be performed that identifies any overlap or redundancies in the selected 108 companies. For example, the auto-correction process 110 may find both ‘Dell’ and ‘Dell Technologies’ in the list, and may remove ‘Dell Technologies’ so that only a single entity, ‘Dell,’ appears in the list.

The next part of the method 100 may involve feature engineering. More particularly, one or more features may be identified, extracted, and normalized, 112. As part of, or prior to, this process 112, one or more databases may be identified from which the various features will be extracted. After feature identification, extraction, and normalization 112 have been performed, a weights estimation process 114 may be performed that calculates a weight for each feature, and then assigns that weight to the feature.

Finally, the method 110 may advance and an index computation process 116 may be performed. The index computation may involve, for each company, using the selected features and computed weights to calculate an index value for that company. The companies may then be ranked in the index according to their respective index values.

### E. Further Example Embodiments

Following are some further example embodiments of the invention. These are presented only by way of example and are not intended to limit the scope of the invention in any way.

Embodiment 1. A method, comprising: identifying companies involved in development and/or use of a technology, wherein identifying the companies comprises: identifying datasets from which features are to be extracted, wherein each feature comprises an aspect of one of the companies that relates to the technology; and extracting the features from the datasets; selecting a subset of the identified companies; for each feature assigned to a company in the subset, normalizing a value of the feature relative to respective values of all other features assigned to that company; assigning a weight to each of the features whose value has been normalized; calculating, for each company in the subset, an index value based on the features assigned to that company and the weights assigned to those features; and generating an index that ranks the companies in the subset by their respective index values.

Embodiment 2. The method as recited in embodiment 1, wherein the aspects comprise any one or more of patent applications filed, patents granted, a jobs count, a technology trend, market sentiment, and an analyst opinion.

Embodiment 3. The method as recited in any of embodiments 1-2, wherein the databases comprise one or more of a jobs database, a database of analyst opinions concerning one or more companies, a trends database, a market sentiment database, and a patents database.

Embodiment 4. The method as recited in any of embodiments 1-3, wherein the assigned weights minimize a volatility of the index, while also maximizing a diversification of the data sources upon which the index is based.

Embodiment 5. The method as recited in any of embodiments 1-4, wherein the assigned weights minimize a variance of the index, while also maximizing a mean of the index.

Embodiment 6. The method as recited in any of embodiments 1-5, wherein calculating the index value for one of the companies comprises applying a weighted average to the features assigned to that company using the assigned weights.

Embodiment 7. The method as recited in any of embodiments 1-6, further comprising using the index as a basis for a decision relating to development and/or use of the technology.

Embodiment 8. The method as recited in any of embodiments 1-7, wherein the extracting comprises processing, independently, respective raw data of each dataset to obtain one or more of the features.

Embodiment 9. The method as recited in any of embodiments 1-8, further comprising using the index to identify where a company is positioned relative to its peers with respect to development and/or use of the technology by that company.

Embodiment 10. The method as recited in any of embodiments 1-9, wherein the weights are optimized in part by ensuring that all the weights sum to 100%, and by ensuring that all weights have a positive value.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

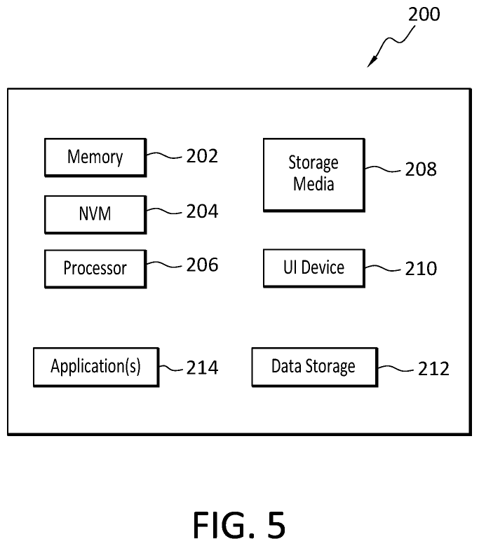

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 200. As well, where any of the aforementioned elements comprise or consist of a virtual machine (VM), that VM may constitute a virtualization of any combination of the physical components disclosed in FIG. 5.

In the example of FIG. 5, the physical computing device 200 includes a memory 202 which may include one, some, or all, of random access memory (RAM), non-volatile memory (NVM) 204 such as NVRAM for example, read-only memory (ROM), and persistent memory, one or more hardware processors 206, non-transitory storage media 208, UI device 210, and data storage 212. One or more of the memory components 202 of the physical computing device 200 may take the form of solid state device (SSD) storage. As well, one or more applications 214 may be provided that comprise instructions executable by one or more hardware processors 206 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
identifying companies involved in development and/or use of a technology, wherein identifying the companies comprises:
identifying datasets from which features are to be extracted, wherein each feature comprises an aspect of one of the companies that relates to the technology; and
extracting the features from the datasets;
selecting a subset of the identified companies;
for each feature assigned to a company in the subset, normalizing a value of the feature relative to respective values of all other features assigned to that company;
assigning a weight to each of the features whose value has been normalized;
calculating, for each company in the subset, an index value based on the features assigned to that company and the weights assigned to those features; and
generating an index that ranks the companies in the subset by their respective index values.

2. The method as recited in claim 1, wherein the aspects comprise any one or more of patent applications filed, patents granted, a jobs count, a technology trend, market sentiment, and an analyst opinion.

3. The method as recited in claim 1, wherein the databases comprise one or more of a jobs database, a database of analyst opinions concerning one or more companies, a trends database, a market sentiment database, and a patents database.

4. The method as recited in claim 1, wherein the assigned weights minimize a volatility of the index, while also maximizing a diversification of the data sources upon which the index is based.

5. The method as recited in claim 1, wherein the assigned weights minimize a variance of the index, while also maximizing a mean of the index.

6. The method as recited in claim 1, wherein calculating the index value for one of the companies comprises applying a weighted average to the features assigned to that company using the assigned weights.

7. The method as recited in claim 1, further comprising using the index as a basis for a decision relating to development and/or use of the technology.

8. The method as recited in claim 1, wherein the extracting comprises processing, independently, respective raw data of each dataset to obtain one or more of the features.

9. The method as recited in claim 1, further comprising using the index to identify where a company is positioned relative to its peers with respect to development and/or use of the technology by that company.

10. The method as recited in claim 1, wherein the weights are optimized in part by ensuring that all the weights sum to 100%, and by ensuring that all weights have a positive value.

11. A computer readable storage medium having stored therein instructions that are executable by one or more hardware processors to perform operations comprising:
identifying companies involved in development and/or use of a technology, wherein identifying the companies comprises:
identifying datasets from which features are to be extracted, wherein each feature comprises an aspect of one of the companies that relates to the technology; and
extracting the features from the datasets;
selecting a subset of the identified companies;
for each feature assigned to a company in the subset, normalizing a value of the feature relative to respective values of all other features assigned to that company;
assigning a weight to each of the features whose value has been normalized;
calculating, for each company in the subset, an index value based on the features assigned to that company and the weights assigned to those features; and
generating an index that ranks the companies in the subset by their respective index values.

12. The computer readable storage medium as recited in claim 11, wherein the aspects comprise any one or more of patent applications filed, patents granted, a jobs count, a technology trend, market sentiment, and an analyst opinion.

13. The computer readable storage medium as recited in claim 11, wherein the databases comprise one or more of a jobs database, a database of analyst opinions concerning one or more companies, a trends database, a market sentiment database, and a patents database.

14. The computer readable storage medium as recited in claim 11, wherein the assigned weights minimize a volatility of the index, while also maximizing a diversification of the data sources upon which the index is based.

15. The computer readable storage medium as recited in claim 11, wherein the assigned weights minimize a variance of the index, while also maximizing a mean of the index.

16. The computer readable storage medium as recited in claim 11, wherein calculating the index value for one of the companies comprises applying a weighted average to the features assigned to that company using the assigned weights.

17. The computer readable storage medium as recited in claim 11, wherein the operations further comprise using the index as a basis for a decision relating to development and/or use of the technology.

18. The computer readable storage medium as recited in claim 11, wherein the extracting comprises processing, independently, respective raw data of each dataset to obtain one or more of the features.

19. The computer readable storage medium as recited in claim 11, wherein the operations further comprise using the index to identify where a company is positioned relative to its peers with respect to development and/or use of the technology by that company.

20. The computer readable storage medium as recited in claim 11, wherein the weights are optimized in part by ensuring that all the weights sum to 100%, and by ensuring that all weights have a positive value.
